(19) United States
(12) Patent Application Publication
(10) Pub. No.: US 2005/0057491 A1
(43) Pub. Date: Mar. 17, 2005

(54) Private display system

(75) Inventors: Carolyn A. Zacks, Rochester, NY (US); Dan Harel, Rochester, NY (US); Frank Marino, Rochester, NY (US); Karen M. Taxier, Rochester, NY (US); Michael J. Telek, Pittsford, NY (US); Alan L. Wertheimer, Pittsford, NY (US)

Correspondence Address: Milton S. Sales;Patent Legal Staff, Eastman Kodak Company, 343 State Street, Rochester, NY, 14650-2201, US

(73) Assignee: Eastman Kodak Company

(21) Appl. No.: 10/650,896

(22) Filed: Aug. 28, 2003

(51) Int. Cl. G09G 5/00

(52) U.S. Cl. 345/156

(57) ABSTRACT

Methods and control systems are provided for operating a display capable of presenting content within a presentation space. In accordance with the method, a person is located in the presentation space and a viewing space is defined comprising less than all of the presentation space and including the location of the person. Content is presented so that the presented content is discernable only within the viewing space.

### FIELD OF THE INVENTION

The present invention relates generally to display systems.

### BACKGROUND OF THE INVENTION

Large-scale video display systems such as rear and front projection television systems, plasma displays, and other types of displays are becoming increasingly popular and affordable. Often such large scale video display systems are matched with surround sound and other advanced audio systems in order to present audio/visual content in a way that is more immediate and enjoyable for people. Many new homes and offices are even being built with media rooms or amphitheaters designed to accommodate such systems.

Increasingly, such large-scale video displays are also being usefully combined with personal computing systems and other information processing technologies such as internet appliances, digital cable programming, and interactive web based television systems that permit such display systems to be used as part of advanced imaging applications such as videoconferencing, simulations, games, interactive programming, immersive programming and general purpose computing. In many of these applications, the large video display systems are used to present information of a confidential nature such as financial transactions, medical records, and personal communications.

One inherent problem in the use of such large-scale display systems is that they present content on such a large visual scale that the content is observable over a very large presentation area. Accordingly, observers who may be located at a significant distance from the display system may be able to observe the content without the consent of the intended people. One way of preventing sensitive content from being observed by unintended people is to define physical limits around the display system so that the images presented on the display are visible only within a controlled area. Walls, doors, curtains, barriers, and other simple physical blocking systems can be usefully applied for this purpose. However, it is often inconvenient and occasionally impossible to establish such physical limits. Accordingly, other means are needed to provide the confidentiality and security that are necessary for such large scale video display systems to be used to present content that is of a confidential or sensitive nature.

Another approach is for the display to present content in a way that causes the content to be viewable only within a very narrow fixed range of viewing angles relative to the display. For example, a polarizing screen such as the PF 400 and PF 450 Computer Filter screens sold by 3M Company, St. Paul, Minn., USA can be placed between people and the display in order to block the propagation of image modulated light emitted by the display except within a very narrow angle of view. This prevents people from viewing content presented on the display unless they are positioned directly in front of a monitor or at some other position defined by the arrangement of the polarizing screen. Persons positioned at other viewing angles see only a dark screen. This approach is often not preferred because the narrow angle of view prevents even intended viewers of the content from observing the content when they move out of the fixed position.

U.S. Pat. No. 6,424,323 entitled, “Electronic Device Having A Display” filed by Bell, et al. on Mar. 28, 2001 describes an electronic device, such as a portable telephone or PDA, having a display in the form of a pixel display with an image deflection system overlying the display. The display is controlled to provide at least two independent display images which, when displayed through the image deflection system, are individually visible from different viewing positions relative to the screen. Suitably, the image deflection system comprises a lenticular screen with the lenticles extending horizontally or vertically across the display such that the different views may be seen through tilting of the device. Here too, the images are displayed to fixed positions and it is the relative position of the viewer and the display that determines what is seen.

Another approach involves the use of known displays and related display control programs that use kill buttons or kill switches that an intended audience member can trigger when an unintended audience member enters the presentation space or whenever an audience member feels that the unintended audience member is likely to enter the presentation space. When the kill switch is manually triggered, the display system ceases to present sensitive content, and/or is directed to present different content. This approach requires that at least one audience member divide his or her attention between the content that is being presented and the task of monitoring the presentation space. This can lead to an unnecessary burden on the audience member controlling the kill switch.

Still another approach involves the use of face recognition algorithms. U.S. Pat. Pub. No. U.S. 2002/0135618 entitled “System And Method for Multi-Modal Focus Detection, Referential Ambiguity Resolution and Mood Classification Using Multi-Modal Input” filed by Maes et al. on Feb. 5, 2001 describes a system wherein face recognition algorithms and other algorithms are combined to help a computing system to interact with a user. In the approach described therein, multi-mode inputs are provided to help the system in interpreting commands. For example, a speech recognition system can interpret a command while a video system determines who issued the command. However, the system described therein does not consider the problem of preventing surreptitious observation of the contents of the display.

Thus what is needed is a display system and a display method that adaptively limits the presentation of content so that the content can be observed only by intended viewers and yet allows the intended viewers to move within a range of positions within a presentation space. What is also needed is a display system that is operable in both a mode for displaying content in a conventional fashion yet is also operable for presenting content for observation only by intended viewers within the presentation space.

### SUMMARY OF THE INVENTION

In one aspect of the invention a method is provided for operating a display capable of presenting content within a presentation space. In accordance with the method, a person is located in the presentation space and a viewing space is defined comprising less than all of the presentation space and including the location of the person. Content is presented so that the presented content is discernable only within the viewing space.

In another aspect of the invention, a method for presenting content using a display is provided. In accordance with the method, people are detected in a presentation space within which content presented by the display can be observed. The people are identified in the presentation space who are authorized to observe the content. A viewing space is defined for each authorized person with each viewing space comprising less than all of the presentation space and including space corresponding to an authorized person and content is presented to each viewing space.

In still another aspect of the invention, a method for operating a display capable of presenting content discernable in a presentation space is provided. In accordance with the method, one of a general display mode and a restricted display mode is selected. Content is presented to the presentation space when the general display mode is selected; and when the restricted display mode is selected a person is located in the presentation space, a viewing space is defined comprising less than all of the presentation space and including the location of the person. Content is presented so that the presented content is discernable only within the viewing space.

In another aspect of the invention, a method for operating a display capable of presenting content within a presentation space is provided. In accordance with the method, content is selected for presentation and access privileges are determined for a person to observe the content. The display is in a first mode wherein the content is displayed to the presentation space when the access privileges are within a first range of access privileges; and the display is operated in a second mode when the access privileges are within a second range of access privileges. During the second mode, a viewing space is defined comprising less than all of the presentation space and including the location of the person; and content is presented so that the presented content is discernable only within the viewing space.

In another aspect of the invention, a control system is provided presenting images to at least one person in a presentation space. The control system has a presentation space monitoring system generating a monitoring signal representative of conditions in the presentation space within which content presented by the display can be discerned and an image modulator positioned between the display and the presentation space with the image modulator adapted to receive patterns of light presented by the display and to modulate the patterns of light emitted by the display so that the patterns of light are discernable only within spaces defined by the image modulator. A processor is adapted to determine the location of each person in the presentation space based upon the monitoring signal and to determine a viewing space for each person in said presentation space comprising less than all of the presentation space and also including the location of each person. Wherein the processor causes the image modulator to modulate the light emitted by the display so that the pattern of light emitted by the display is discernable only in the viewing space.

In another aspect of the invention, a control system is provided for a display adapted to present images in the form of patterns of light that are discernable in a presentation space. The control system has a presentation space monitoring system generating a monitoring signal representative of conditions in the presentation space and an image modulator positioned between the display and the person with the image modulator adapted to receive patterns of light presented by the display and for modulating the patterns of light emitted by the display. A processor is adapted to select between operating in a restricted mode and a general mode. The processor is further adapted to, in the general mode, cause the image modulator and display to present content in a manner that is discernable throughout the display space and with the processor further being adapted to, in the restricted mode, detect each person in the presentation space based upon the monitoring signal, define viewing spaces for each person in the presentation space and cause the image modulator and display to cooperate to present images that are discernable only within each viewing space.

In yet another aspect of the invention a control system is provided for a display adapted to present images in the form of patterns of light that are discernable in a presentation space. The control system has a presentation space monitoring system generating a monitoring signal representative of conditions in the presentation space and an image modulator positioned between the display and the person with the image modulator adapted to receive patterns of light presented by the display and to modulate the patterns of light emitted by the display so that the patterns of light are discernable only within spaces defined by the image modulator. A processor is adapted to detect each person in the presentation space based upon the monitoring signal, to identify authorized persons based on this comparison; and to determine a viewing space for each authorized person said viewing space comprising less than all of the presentation space and also including the location of the person. Wherein the processor causes the image modulator and the display to cooperate to modulate the light emitted by the display so that the pattern of light emitted by the display is discernable only in viewing spaces for authorized persons.

In a further aspect of the invention, a control system for a display adapted to present light images to a presentation space is provided, the control system comprising a detection means for detecting at least one person in the presentation space and an image modulator for modulating the light images. A processor is adapted to obtain images for presentation on the display, to determine a profile for the obtained images and to select a mode of operation based upon information contained in the profile for the obtained images. Wherein the processor is operable to cause the display to present images in two modes and selects between the modes based upon the content profile information and wherein in one mode the images are presented to the presentation space and in another mode at least one viewing space is defined around each person with each viewing space comprising less than the entire presentation space and to cause images to be formed on the display in a way such that when the images are modulated by the image modulator so that the images are only viewable to a person in the at least one viewing space.

### BRIEF DESCRIPTION OF THE DRAWINGS

FIG. 1 shows a block diagram of one embodiment of a display system of the present invention.

FIG. 2 shows an illustration of a presentation space having a viewing space therein.

FIG. 3 shows an illustration of the operation of one embodiment of an image modulator.

FIGS. 4a-4c illustrate various embodiments of an array of micro-lenses.

FIG. 5 illustrates ranges of viewing areas that can be defined using groups of image elements having particular widths.

FIG. 6 is a flow diagram of one embodiment of a method of the present invention.

FIG. 7 is a flow diagram of an optional calibration process.

FIG. 8 is a flow diagram of another embodiment of the method of the present invention.

FIG. 9 is an illustration of one application of the present invention in a video-conferencing application.

FIG. 10 shows an alternate embodiment of a modulator.

### DETAILED DESCRIPTION OF THE INVENTION

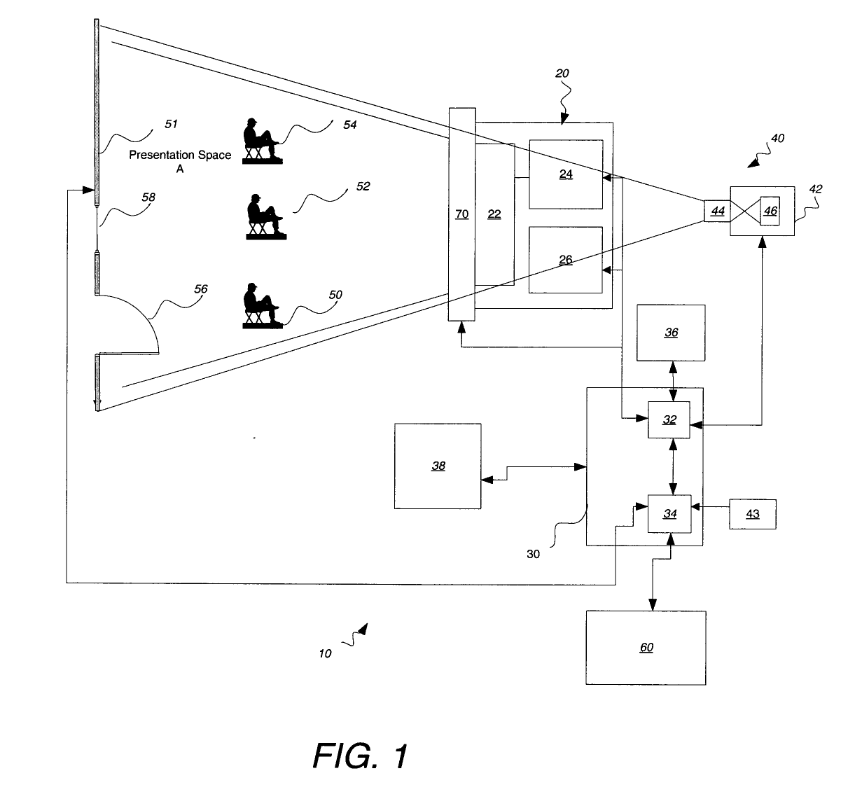

FIG. 1 shows one embodiment of a presentation system 10. In the embodiment shown in FIG. 1, presentation system 10 comprises a display device 20 such as an analog television, a digital television, computer monitor, projection system or other apparatus capable of receiving signals containing images or other visual content and converting the signals into an image that can be discerned in a presentation space A. As used herein, the term content refers to any form of video, audio, text, affective or graphic information or representations and any combination thereof. Display device 20 comprises a source of image modulated light 22 such as a cathode ray tube, a liquid crystal display, an organic light emitting display, an organic electroluminescent display, a cholesteric or other bi-stable type display or other type of display element. Alternatively, the source of image modulated light 22 can comprise any other form of front or rear projection display systems known in the art. A display driver 24 is also provided. Display driver 24 receives image signals and converts these image signals into signals that cause the source of image modulated light 22 to display an image.

Presentation system 10 also comprises an audio system 26. Audio system 26 can comprise a conventional monaural or stereo sound system capable of presenting audio components of the content in a manner that can be detected throughout presentation space A. Alternatively, audio system 26 can comprise a surround sound system which provides a systematic method for providing more than two channels of associated audio content into presentation space A. Audio system 26 can also comprise other forms of audio systems that can be used to direct audio to specific portions of presentation space A. One example of such a directed audio system is described in commonly assigned U.S. patent application Ser. No. 09/467,235, entitled “Pictorial Display Device With Directional Audio” filed by Agostinelli et al. on Dec. 20, 1999.

Presentation system 10 also incorporates a control system 30. Control system 30 comprises a signal processor 32, a controller 34 and an image modulator 70. A supply of content 36 provides a content bearing signal to signal processor 32. Supply of content 36 can comprise, for example, a digital videodisc player, a videocassette player, a computer, a digital or analog video or still camera, a scanner, cable television network, the Internet or other telecommunication system, an electronic memory or other electronic system capable of conveying a signal containing content for presentation. Signal processor 32 receives this content and adapts the content for presentation. In this regard, signal processor 32 extracts video content from a signal bearing the content and generates signals that cause the source of image modulated light 22 to display the video content. Similarly, signal processor 32 extracts audio signals from the content bearing signal. The extracted audio signals are provided to audio system 26 which converts the audio signals into an audible form that can be heard in presentation space A.

Controller 34 selectively causes images received by signal processor 32 to be presented by the source of image modulated light 22. In the embodiment shown in FIG. 1, a user interface 38 is provided to permit local control over various features of presentation system 10. User interface 38 can comprise any form of transducer or other device capable of receiving an input from a user and converting this input into a form that can be used by controller 34 in operating presentation system 10. For example, user interface 38 can comprise a touch screen input, a touch pad input, a 4-way switch, a 5-way switch, a 6-way switch, an 8-way switch, or any other multi-way switch structure, a stylus system, a trackball system, a joystick system, a voice recognition system, a gesture recognition system or other such systems. User interface 38 can be fixedly incorporated into presentation system 10 and alternatively some or all of the portions of user interface 38 can be separable from presentation system 10 so as to provide a remote control (not shown).

User interface 38 can include an activation button that sends a trigger signal to controller 34 indicating a desire to present content as well as other controls useful in the operation of display device 20. For example, user interface 38 can be adapted to allow one or more people to enter system adjustment preferences such as hue, contrast, brightness, audio volume, content channel selections etc. Controller 34 receives signals from user interface 38 that characterize the adjustments requested by the user and will provide appropriate instructions to signal processor 32 to cause images presented by display device 20 to take on the requested system adjustments.

Similarly, user interface 38 can be adapted to allow a user of presentation system 10 to enter inputs to enable or disable presentation system 10 and/or to select particular channels of content for presentation by presentation system 10. User interface 38 can provide other inputs for use in calibration as will be described in greater detail below. For example, user interface 38 can be adapted with a voice recognition module that recognizes audible output and provides recognition into signals that can be used by controller 34 to control operation of the device.

Presentation space monitoring system 40 is also provided to sample presentation space A and, optionally, spaces adjacent to presentation space A and to provide sampling signals from which signal processor 32 and/or controller 34 can detect people in presentation space A and/or people approaching presentation space A. As is noted above, presentation space A will comprise any space or area in which the content presented by presentation system 10 can be viewed, observed perceived or otherwise discerned. Presentation space A can take many forms and can be dependent upon the environment in which presentation system 10 is operated and the image presentation capabilities of presentation system 10. For example, in the embodiment shown in FIG. 1, presentation space A is defined in part as the space between display device 20 and wall 51 because wall 51 blocks light emitted by the source of image modulated light 22. Because wall 51 has door 56 and window 58 through which content presented by presentation system 10 can be observed, presentation space A can include areas beyond wall 51 that are proximate to these.

Alternatively, where presentation system 10 is operated in an open space such as a display area in a retail store, a train station or an airport terminal, presentation space A will be limited by the optical display capabilities of presentation system 10. Similarly where presentation system 10 is operated in a mobile environment, presentation space A can change as presentation system 10 is moved.

In the embodiment shown in FIG. 1, presentation space monitoring system 40 comprises a conventional image capture device such as an analog or digital image capture unit 42 comprising a taking lens unit 44 that focuses light from a scene onto an image sensor 46 that converts the light into electronic signal. Taking lens unit 44 and image sensor 46 cooperate to capture sampling images that include presentation space A. In this embodiment, the sampling signal comprises at least one sampling image. The sampling signal is supplied to signal processor 32 which analyzes sampling signal to determine the location of people in and/or near presentation space A. In certain embodiments, controller 34 can also be used to analyze the sampling signal.

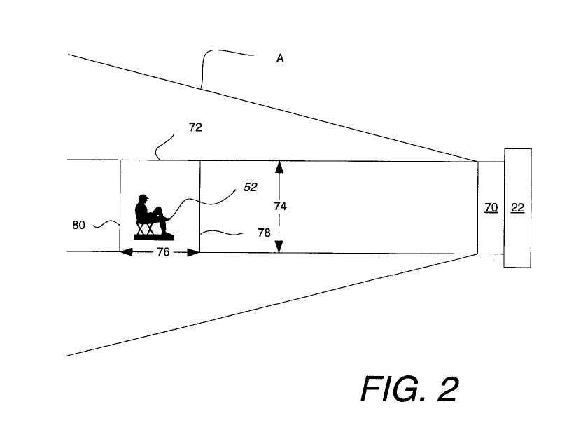

FIGS. 1-3 show image modulator 70 positioned between source of image modulated light 22 and people 50, 52, and 54. Image modulator 70 receives light images from source of image modulated light 22 and causes the images formed by source of image modulated light 22 to be discernable only when viewed by a person such as person 52 within viewing space 72. As shown in FIG. 2, viewing space 72 includes less than all of presentation space A but also includes a location proximate to person 52.

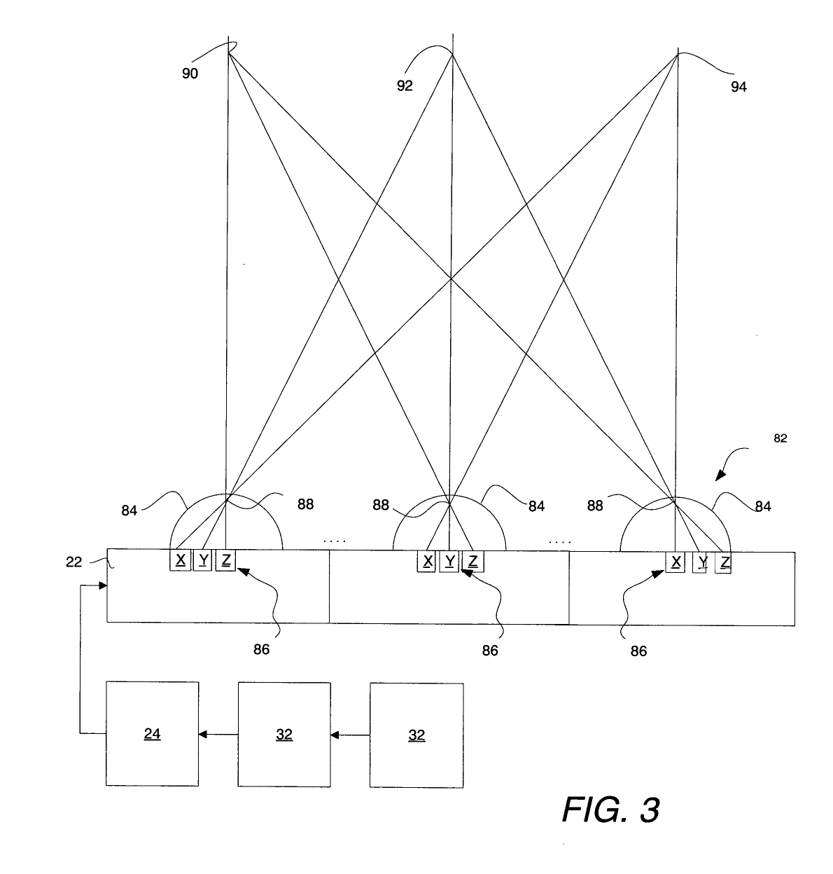

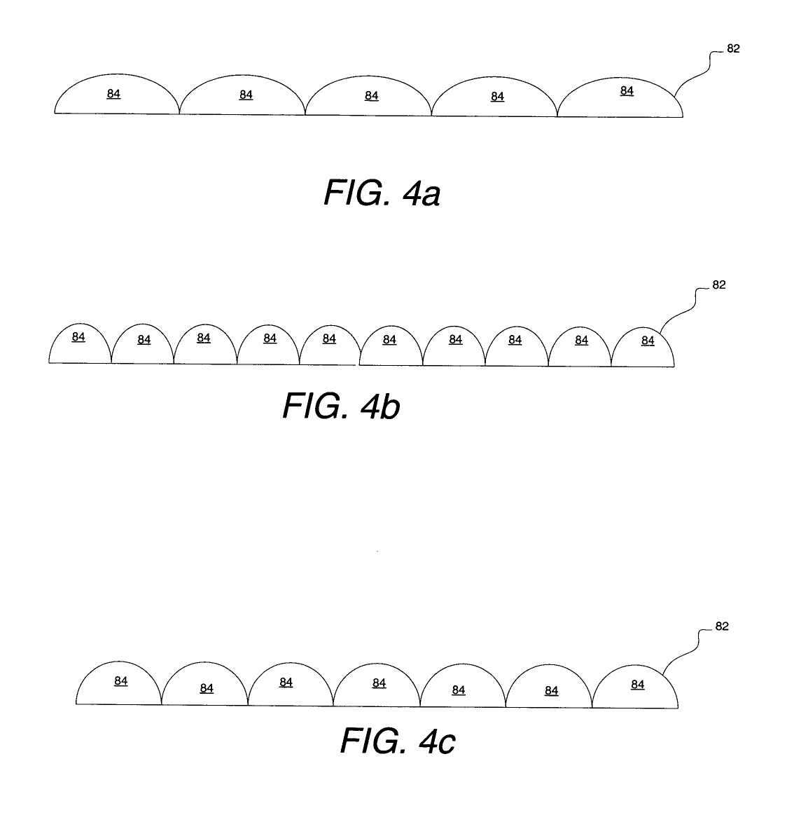

Image modulator 70 can take many forms. FIG. 3 illustrates a cross section view of one embodiment of image modulator 70 comprising an array 82 of micro-lenses 84 operated in cooperation with source of image modulated light 22, display driver 24, signal processor 32 and/or controller 34. Array 82 of micro-lenses 84 can take one of many forms. For example, as is shown in FIGS. 4a and 4b, array 82 can comprise hemi-aspherical micro-lenses 86 or as shown in FIG. 4c array 82 can comprise hemi-spherical micro-lenses 86. However, the diagrams equally represent in cross-section hemi-cylindrical or hemi-acylindrical micro-lenses 84. Array 82 can also include micro-lenses 84 but are not limited to spherical, cylindrical, ashprerical, or acylindrical micro-lenses 84.

FIG. 3 shows a source of image modulated light 22 having an array of controllable image elements 86, each capable of providing variable levels of light output and array 82 of micro-lenses 84 arranged in concert therewith. In certain embodiments, the source of image modulated light 22 and array 82 of micro-lenses 84 can be integrally formed using a common substrate. This helps to ensure that image elements 86 of source of image modulated light 22 are aligned with each micro-lens 84 of array 82. In other embodiments, the source of image modulated light 22 and the array 82 of micro-lenses 84 can be separate but joined in an aligned relationship.

In the embodiment illustrated in FIG. 3, each micro-lens 84 is aligned in concert with image elements 86 in groups designated as X, Y and Z. In operation, signal processor 32 can cause source of image modulated light 22 to present images using only image elements 86 of group X, only image elements 86 associated with group B, only image elements 86 associated with group C or any combination thereof. Light emitted by or passing through each picture element 86 passes through an optical axis 88 of each associated micro-lens 84. Accordingly, as is also shown in FIG. 3, when an image is presented using only image elements of group X, an observer located at position 94 will be able to observe the image while an observer standing at one of positions 90 and 92 will not be able to observe the image. Similarly, when an image is presented using only image elements 86 of group Y an observer located at position 92 will be able to observe the content while an observer standing at one of positions 90 or 94 will not be able to observe the content. Further, when an image is presented using only image elements 86 of group Z an observer located at position 90 will be able to observe the content while an observer standing at one of positions 92 or 94 will not be able to observe the content.

Thus, by using an image modulator 70 with a co-designed signal processor 32 it is possible to operate display device 20 in a manner that causes images presented by source of image modulated light 22 to be directed so that they reach only viewing space 72 within presentation space A. As more groups of separately controllable image elements 86 are interposed behind each micro-lens 84, it becomes possible define more than three viewing areas in presentation space A. For example, twenty or more groups of image elements can be defined in association with a particular micro-lens to divide the presentation space A into twenty portions or more portions so that content presented using display system 10 can be limited to an area that is at most 1/20^{th} of the overall presentation space A.

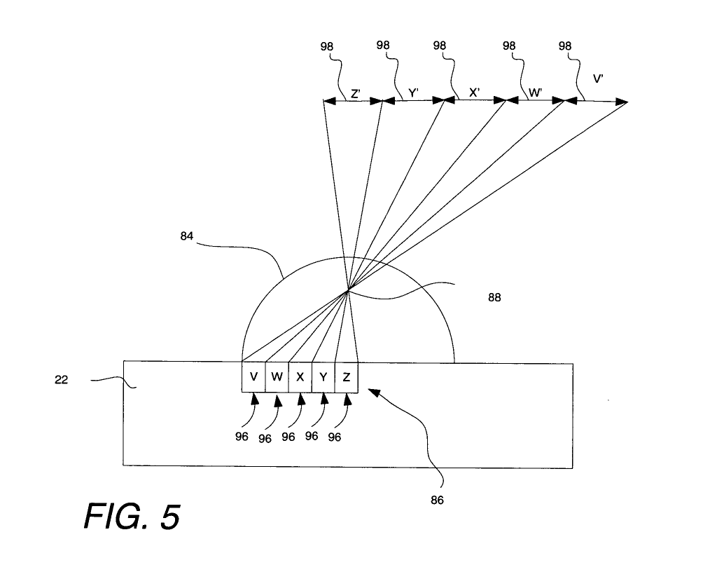

However, other arrangements are possible. For example, groups of image elements 86 such as groups X, Y and Z can comprise individual image elements 86 or multiple image elements 86. As is shown in FIG. 5, source of image modulated light 22 has groups V, W, X, Y and Z each group has a group width 96 that defines, in part, a range of viewing positions 98 at which content presented using the image elements 86 of the group can be observed. Group width 96 and displacement of a group relative to the position of optical axis 88 of an associated micro-lens 72 determines the location and overall width of an associated range of viewing position 98. In one embodiment of the present invention, each micro-lens 84 is arranged proximate to an array of image elements 86 with display driver 24 and/or signal processor 32 programmed to adaptively select individual image elements 86 for use in forming images. In such an embodiment, both the group width 96 and the displacement of the group of image elements 86 relative to the optical axis 88 of each micro-lens 84 can be adjusted to adaptively define the range of viewing position 98 and position of the viewing space 72 in a way that dynamically tracks the movements of a person 52 within presentation space A.

Thus, using this embodiment of image modulator 70 it is possible to present content in a way that is discernable only at a particular position or range of positions relative to the source of image modulated light 22 and within a range of positions. This position can be defined vertically or horizontally with respect to the presentation screen. For example, array 82 can comprise an array of hemi-cylindrical micro-lenses 84 arranged with the optical axis 88 arranged vertically, horizontally or diagonally so that viewing areas can be defined horizontally, vertically or along both axes. Similarly an array 82 of hemispherical micro-lenses can be arranged with imaging elements 86 defined with relation thereto so that viewing spaces can be defined having two degrees of restriction. Three degrees of restriction can be provided where a depth 76 of viewings space 72 is controlled as will be described in greater detail below.

By causing the same image to appear at groups V, W, X, Y, and Z the presented image can be made to appear continuously across ranges V′, W′, X′ Y′ and Z′ so that presentation system 10 appears to be presented in a conventional manner. Thus, presentation system 10 can be made operable in both a conventional presentation mode and in a mode that limits the presentation of content to one or more viewing spaces.

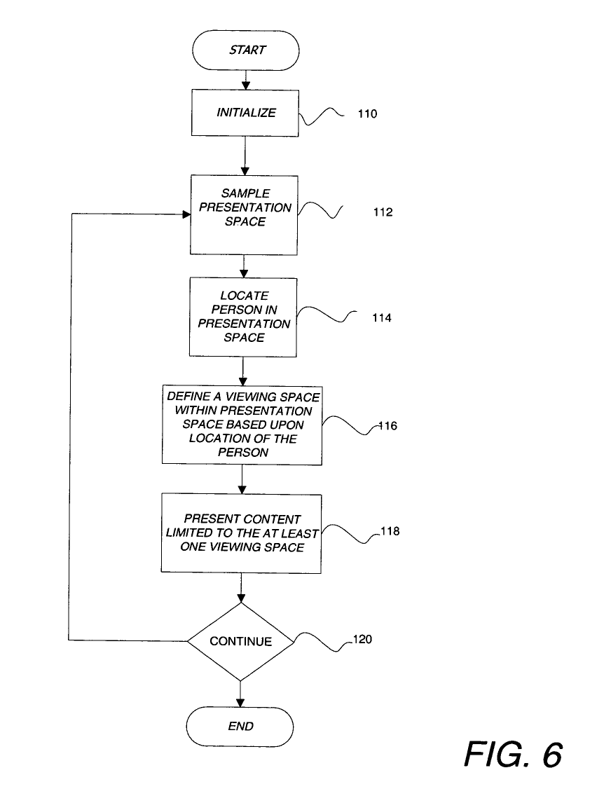

FIG. 6 shows a flow diagram of one embodiment of a method for operating presentation system 10 having an image modulator 70. In a first step of the method, operation of presentation system 10 of the present invention is initiated (step 110). This can be done in response to a command issued by a person in presentation space A, typically made using user interface 38. Alternatively, this can be done automatically in response to preprogrammed preferences and/or by using presentation space monitoring system 40 to monitor presentation space A and to cooperate with signal processor 32 and controller 34 to determine when to operate presentation system 10 to present the content based upon analysis of a sampling signal provided by monitoring system 40. Other methods for initiating operation of presentation system 10 can be used.

Controller 34 causes presentation space monitoring system 40 to sample presentation space A (step 112). In the embodiment of FIG. 1, this is done by capturing an image or multiple images of presentation space A and, optionally, areas adjacent to presentation space A using image capture unit 42. These images are optionally processed, and provided to signal processor 32 and/or controller 34 as a sampling signal.

The sampling signal is then processed by signal processor 32 to locate people in presentation space A (step 114). Because, in this embodiment, the sampling signal is based upon images of presentation space A, people are located in presentation space A by use of image analysis. There are various ways in which people can be located in an image captured of presentation space A. For example, presentation space monitoring system 40 can comprise an image sensor 46 that is capable of capturing images that include image content obtained from light that is in the infra-red spectrum. People can be identified in presentation space A by examining images of the scene to detect heat signatures that can be associated with people. For example, the sampling image can be analyzed to detect, for example, oval shaped objects having a temperature range between 95 degrees Fahrenheit and 103 degrees Fahrenheit. This allows for ready discrimination between people, pets and other background in the image information contained in the sampling signal.

In still another alternative, people can be located in the presentation space by using image analysis algorithms such as those disclosed in commonly assigned U.S. Pat. Pub. No. 2002/0076100 entitled “Image Processing Method for Detecting Human Figures in a Digital Image” filed by Lou on Dec. 14, 2000. Alternatively, people can be more specifically identified by classification. For example, the size, shape or other general appearance of people can be used to separate adult people from younger people in presentation space A. This distinction can be used to identify content to be presented to particular portions of presentation space A and for other purposes as will be described herein below. Face detection algorithms such as those described in commonly assigned U.S. Pat. Pub. No. 2003/0021448 entitled “Method for Detecting Eye and Mouth Positions in a Digital Image” filed by Chen et al. on May 1, 2001, can be used to locate human faces in the presentation space. Once faces are identified in presentation space A, well known face recognition algorithms can be applied to selectively identify particular persons in presentation space A. This too can be used to further refine what is presented using display system 10 as will be described in greater detail below.

After at least one person has been located in presentation space A, at least one viewing space comprising less than all of the presentation space and including the location of the person is determined (step 114). Each viewing space includes a space proximate to the person with the space being defined such that a person positioned in that space can observe the content.

The extent to which viewing space 72 expands around the location of person 52 can vary. For example, as is shown in FIG. 2, viewing space 72 can be defined in terms of an area having, generally, a width 74 and a depth 76. As described above width 74 of viewing space 72 can be defined using image modulator 70 of FIG. 3 by defining width 96 of a group of image elements 86 which, as described with reference to FIG. 5, causes a concomitant adjustment in width 74 of range 98 in which an image presented by a group of image elements 86 can be observed.

Width 74 of viewing space 72 can be defined in accordance with various criteria. For example width 74 can be defined at a width that is no less than the eye separation of person 52 in viewing space 72. Such an arrangement significantly limits the possibility that persons other than those for whom the content is displayed will be able to observe or otherwise discern the content.

Alternatively, width 74 of viewing space 72 can be defined in part based upon the shoulder width of person 52. In such an alternative embodiment viewing space 72 is defined to be limited to the actual shoulder width or based upon an assumed shoulder width. Such an arrangement permits normal movement of the head of person 52 without impairing the ability of person 52 to observe the content presented on presentation system 10. This shoulder width arrangement also meaningfully limits the possibility that persons other than the person or persons for whom the content is displayed will be able to see the content as it is unlikely that such persons will have access to such a space. In still other alternative embodiments other widths can be used for the viewing space and other criteria can be applied for presenting the content.

Viewing space 72 can also be defined in terms of a viewing depth 76 or a range of distances from source of image modulated light 22 at which the content presented by display device 20 can be viewed. In certain embodiments, depth 76 can be defined, at least in part, by at least one of a near viewing distance 78 comprising a minimum separation from source of image modulated light 22 at which person 52 located in viewing space 72 can discern the presented content and a far viewing distance 80 comprising a maximum distance from source of image modulated light 22 at which person 52 can discern content presented to viewing space 72. In one embodiment, depth 76 of viewing space 72 can extend from source of image modulated light 22 to infinity. In another embodiment, depth 76 of viewing space 72 can be restricted to a minimum amount of space sufficient to allow person 52 to move her head within a range of normal head movement while in a stationary position without interrupting the presentation of content. Other convenient ranges can be used with a more narrow depth 76 and/or more broad depth 76 being used.

Depth of viewing space 76 of viewing space 72 can be controlled in various ways. For example, content presented by the source of image modulated light 22 and image modulator 70 is viewable within a depth of focus relative to the image modulator 70. This depth of focus is provided in one embodiment by the focus distance of micro-lenses 84 of array 82. In another embodiment, image modulator 70 can comprise a focusing lens system (not shown) such as an arrangement of optical lens elements of the type used for focusing conventionally presented images. Such a focusing lens system can be adjustable within a range of focus distances to define a depth of focus in the presentation space that is intended to correspond with a desired depth 76.

Alternatively, it will be appreciated that light propagating from each adjacent micro-lens 84 expands as it propagates and, at a point at a distance from display device 20, the light from one group of image elements 86 combines with light from another group of image elements 86. This combination can make it difficult to discern what is being presented by any one group of image elements. In one embodiment, depth 76 of viewing space 72 can be defined to have a far viewing distance 80 that is defined as a point wherein the content presented by one or more groups of image elements 86 becomes difficult to discern because of interference from content presented by other groups. Signal processor 32 and controller 34 can intentionally define groups of image elements 86 that are intended to interfere with the ability of a person standing in presentation space A who is outside viewing space 72 to observe content presented to viewing space 72.

The content is then presented so that the presented content is discernable only within the viewing space (step 118). This can be done as shown and described above by selectively directing image modulated light into a portion of presentation space A. In this way, the image modulated light is only observable within viewing space 72. To help limit the ability of a person to observe the content presented to viewing space 72, alternative images can be presented to areas that are adjacent to viewing space 72. The other content can interfere with the ability of a person to observe the content presented in viewing space 72 and thus reduce the range of positions at which content presented to viewing space 72 can be observed or otherwise discerned.

For example, as shown in FIG. 5, content is presented to a viewing space X′ associated with a group of image elements X. However, adjacent image elements W and Y present conflicting content that makes it difficult to discern content that is displayed to viewing space X′. This helps to ensure that only people within viewing space X can discern the content presented to viewing space X′. Where more than one person is in presentation space A more than one viewing space can be defined within presentation space A. Alternatively, a combined viewing space can be defined to include more than one person.

It is also appreciated that a person 52 can move relative to display device 20. Accordingly, while the presentation of content continues presentation space monitoring system 40 continues to sample presentation space A to detect a location of each person for which a viewing space is defined (step 120). When it is determined that a person has moved relative to presentation system 10 the viewing space for such person can be redefined, as necessary, to ensure continuity of a presentation of the content to such person (steps 114-118).

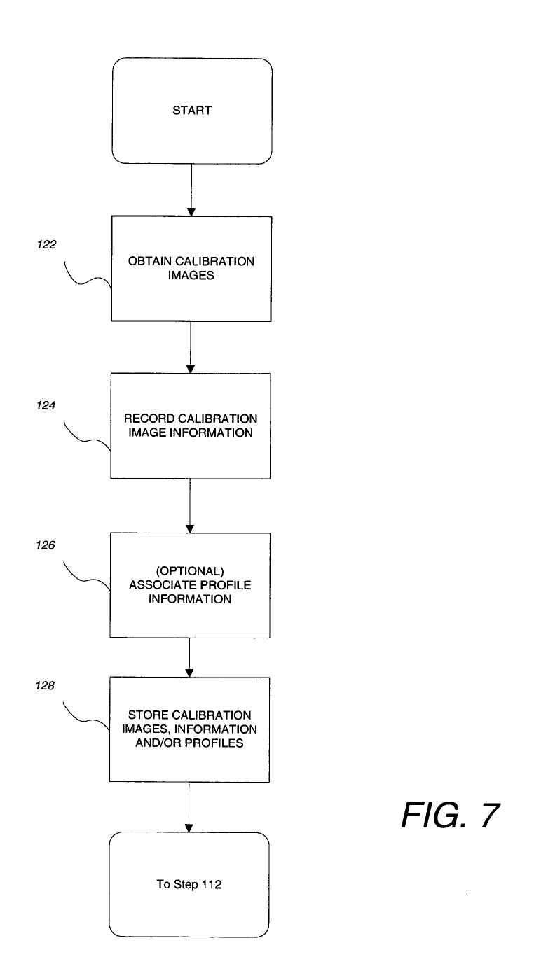

The process of locating people in presentation space A (step 114) can be assisted by use of an optional calibration process. FIG. 7 shows one embodiment of such a calibration process. This embodiment can be performed before content is to be presented using presentation system 10 or afterward. As is shown in FIG. 7, during calibration, image capture unit 42 can be used to capture at least one calibration image of presentation space A (step 122). The calibration image or images can be obtained at a time where no people are located in presentation space A. Where calibration images have been obtained, alternate embodiments of the step of locating people in presentation space A (step 114) can comprise determining that people are located in areas of the control image that do not have an appearance that corresponds to a corresponding portion of the calibration image.

Optionally, a user of presentation system 10 can use user interface 38 to record information in association with the calibration image or images to designate areas that are not likely to contain people (step 124). This designation can be used to modify the calibration image either by cropping the calibration image or by inserting metadata into the calibration image or images indicating that portions of the calibration image or images are not to be searched for people. In this way, various portions of presentation space A imaged by image capture unit 42 that are expected to change during display of the content but wherein the changes are not frequently considered to be relevant to a determination of the privileges associated with the content can be identified. For example, a large grandfather clock (not shown) could be present in the scene. The clock has turning hands on its face and a moving pendulum. Accordingly, where images are captured of the clock over a period of time, changes will occur in the appearance of the clock. However, these changes are not relevant to a determination of the viewing space. Thus, these areas are identified portions of these images that are expected to change over time and signal processor 32 and controller 34 can ignore differences in the appearance of these areas of presentation space A.

Optionally, calibration images can be captured of individual people who are likely to be found in the presentation space (step 122). Such calibration images can, for example, be used to provide information that face recognition algorithms described above can use to enhance the accuracy and reliability of the recognition process. Further, the people depicted in presentation space A can be associated with an identification (step 124). The identification can be used to obtain profile information for such people with the identification information being used for purposes that will be described in greater detail below. Such profile information can be associated with the identification manually or automatically during calibration (step 126). The calibration image or images, any information associated therewith, and the profile information are then stored (step 128). Although the calibration process has been described as a manual calibration process, the calibration process can also be performed in an automatic mode by scanning a presentation space to search for predefined classes of people and for predefined classes of users.

As presentation space monitoring system 40 continues to sample presentation space during presentation of content, signal processor 32 can detect the entry of additional people into presentation space A (step 120). When this occurs, signal processor 32 and controller 34 can cooperate to select an appropriate course of action based upon the detected entry of the person into the presentation space. In one course of action, the presentation of content can be limited to a presentation space about a first person in a presentation space, and additional people who enter presentation space A are not provided with a viewing space 72 until authorized. Person 52, by way of user interface 38, can make such authorization.

Alternatively, signal processor 32 and/or controller 34 can automatically determine whether such persons are authorized to observe the content being presented to viewing space 72 designated for person 52, and adjust viewing space 72 to include such authorized persons. Where users are identified by a user classification i.e. an adult or child or by an identification face recognition algorithm. Controller 34 can use the identification to determine whether content should be presented to persons 50 and 52. Where it is determined that such persons are authorized to observe the content, controller 34 and signal processor 32 can cooperate to cause additional viewing space 72 to be prepared that are appropriate for these persons.

In the embodiment of FIG. 1, profiles for individual people or classes of people can be provided by an optional source of personal profiles 60. The source of personal profiles 60 can be a memory device such as an optical, magnetic or electronic storage device or a storage device provided by the remote network. The source of personal profiles 60 can also comprise an algorithm for execution by a processor such as signal processor 32 or controller 34. Such an algorithm determines profile information for people detected in presentation space A based upon analysis of the sampling signal. These assigned profiles can be used to help select and control the display of image information.

The personal profile identifies the nature of the content that a person in presentation space A is entitled to observe. For example, where it is determined that the person is an adult audience member, the viewing privileges may be broader than the viewing privileges associated with a child audience member. In another example, an audience member may have access to selected information relating to the adult that is not available to other adult people.

The profile can assign viewing privileges in a variety of ways. For example, viewing privileges can be defined with reference to ratings such as those provided by the Motion Picture Association of America (MPAA), Encino, Calif., U.S.A. which rates motion pictures and assigns general ratings to each motion picture. Where this is done, each element is associated with one or more ratings and the viewing privileges associated with the element are defined by the ratings with which it is associated. However, it will also be appreciated that it is possible to assign profiles without individually identifying audience member 50, 52 and 54. This is done by classifying people and assigning a common set of privileges to each class of detected person. Where this is done, profiles can be assigned to each class of viewer. For example, as noted above, people in presentation space A can be classified as adults and children with one set of privileges associated with the adult class of people and another set of privileges associated the child class.

Finally, it may be useful to define a set of privilege conditions for presentation space A when unknown people are present in presentation space A. An unknown profile can be used to define privilege settings where an unknown person or when unknown conditions or things are detected in presentation space A.

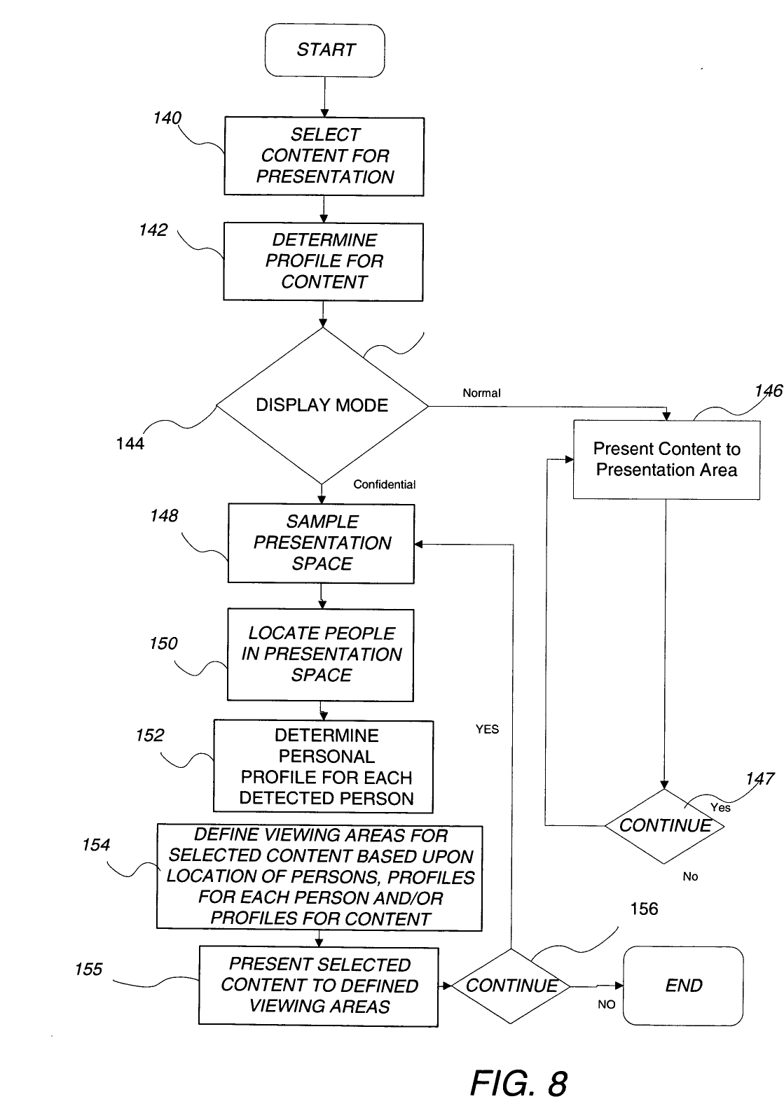

FIG. 8 shows another embodiment of the present invention. In this embodiment, presentation system 10 determines a desire to view content (step 140). Typically, this desire is indicated using user interface 38. Signal processor 32 analyzes signals bearing the selected content and determines access privileges associated with this content (step 142). The access privileges identify a condition or set of conditions that are recommended or required to view the content. For example, MPAA ratings can be used to determine access privileges. Alternatively, the access privileges can be determined by analysis of the proposed content. For example, where presentation system 10 is called upon to present digital information such as from a computer, the content of the information can be analyzed based upon the information contained in the content and a rating can be assigned. Access privileges for a particular content can also be manually assigned during calibration.

In still another alternative, an audience member can define certain classes of content that the audience member desires to define access privileges for. For example, the audience member can define higher levels of access privileges for private content. When the content is analyzed, scenes containing private content can be identified by analysis of the content or by analysis of the metadata associated with the content that indicates the content has private aspects. Such content can then be automatically associated with appropriate access privileges.

Controller 34 then makes an operating mode determination based upon the access privileges associated with the content. Where the content has a relatively low level of access privileges controller 34 can select (step 144) a “normal” operating mode wherein presentation system 10 is adapted to present content over substantially all of presentation space A for the duration of the presentation of the selected content (step 146)

Where controller 34 determines the content is of a confidential or potentially confidential nature, controller 34 causes presentation space 34 to be sampled (step 148). In this embodiment, this sampling is performed when image capture unit 42 captures an image of presentation space A. Depending on the optical characteristics of presentation space monitoring system 40, it may be necessary to capture different images at different depths of field so that the images obtained depict the entire presentation space with sufficient focus to permit identification of people in presentation space A. Presentation space monitoring system 40 generates a sampling signal based upon these images and provides this sampling signal to signal processor 32.

The sampling signal is then analyzed to detect people in presentation space A (step 150). Image analysis tools such as those described above can be used for this purpose. Profiles for each person in the image are then obtained based on this analysis (step 152).

One or more viewing areas are then defined in presentation space A based upon the location of each detected person, the profile for that person and the profile for the content (step 154). Where more than one element is identified in presentation space A, this step involves combining the personal profiles. There are various ways in which this can be done. The personal profiles can be combined in an additive manner with each of the personal profiles examined and content selected based upon the sum of the privileges associated with the people. Table I shows an example of this type. In this example three people are detected in the presentation space, two adults and a child. Each of these people has an assigned profile identifying viewing privileges for the content. In this example, the viewing privileges are based upon the MPAA ratings scale.

| Viewing Privilege | Person I: | Person II: | Person III: | |
|---|---|---|---|---|
| Type (Based On | Adult | Child | Adult | Combined |
| MPAA Ratings) | Profile | Profile | Profile | Privileges |
| G—General | YES | YES | YES | YES |
| Audiences | | | | |
| PG—Parental | YES | NO | YES | YES |
| Guidance Suggested | | | | |
| PG-13—Parents | YES | NO | NO | YES |
| Strongly Cautioned | | | | |

As can be seen in this example, the combined viewing privileges include all of the viewing privileges of the adult even though the child has fewer viewing privileges.

The profiles can also be combined in a subtractive manner. Where this is done profiles for each element in the presentation space are examined and the privileges for the audience are reduced for example, to the lowest level of privileges associated with one of the profiles for one of the people in the room. An example of this is shown in Table II. In this example, the presentation space includes the same adults and child described with reference to Table I.

| Viewing Privilege | Person I: | Person II: | Person III: | |
|---|---|---|---|---|
| Type (Based On | Adult | Child | Adult | Combined |
| MPAA Ratings) | Profile | Profile | Profile | Privileges |
| G—General | YES | YES | YES | YES |
| Audiences | | | | |
| PG—Parental | YES | NO | YES | NO |
| Guidance Suggested | | | | |
| PG-13—Parents | YES | NO | NO | NO |
| Strongly Cautioned | | | | |

However, when the viewing privileges are combined in a subtractive manner, the combined viewing privileges are limited to the privileges of the element having the lowest set of privileges: the child. Other arrangements can also be established. For example, profiles can be determined by analysis of content type such as violent content, mature content, financial content or personal content with each element having a viewing profile associated with each type of content. As a result of such combinations, a set of element viewing privileges is defined which can then be used to make selection decisions.

A viewing space can then be defined for the content based upon the location of persons in presentation space A, the content profile and the profile for each person. For example, a viewing space can then be defined in a presentation space A that combines profiles in an additive fashion as described with reference to Table I and that presents content having a G, PG or PG13 rating to a presentation space that includes both adults and the child of Table I. Alternatively, where personal profiles are combined in a subtractive manner as is described with reference to Table II, one or more viewing spaces will be defined within presentation space A that allow both adults to observe the content but that do not allow the child to observe content that is of a PG or PG-13 rating (step 154).

The content is then presented to the defined presentation spaces (step 155) and the process repeats until it is desired to discontinue the presentation of the content (step 156). During each repetition, presentation space A is monitored and changes in composition of the people and/or things in presentation space A can be detected. Such changes can occur, for example, as people move about in the presentation space. Further, when such changes are detected, the way in which the content is presented can be automatically adjusted to accommodate this change. For example, when an audience member moves from one side of the presentation space to another side of the presentation space, then presented content such as text, graphic, and video people in the display can change relationships within the display to optimize the viewing experience.

Other user preference information can be incorporated into the element profile. For example, as is noted above, presentation system 10 is capable of receiving system adjustments by way of user interface 38. In one embodiment, these adjustments can be entered during the calibration process (step 122) and presentation space monitoring system 40 can be adapted to determine which audience member has entered what adjustments and to incorporate the adjustment preferences with the profile for an image element related to that audience member. During operation, an element in presentation space A is determined to be associated with a particular audience member, signal processor 32 can use the system adjustment preferences to adjust the presented content. Where more than one audience member is identified in presentation space A, the system adjustment preferences can be combined and used to drive operation of presentation system 10.

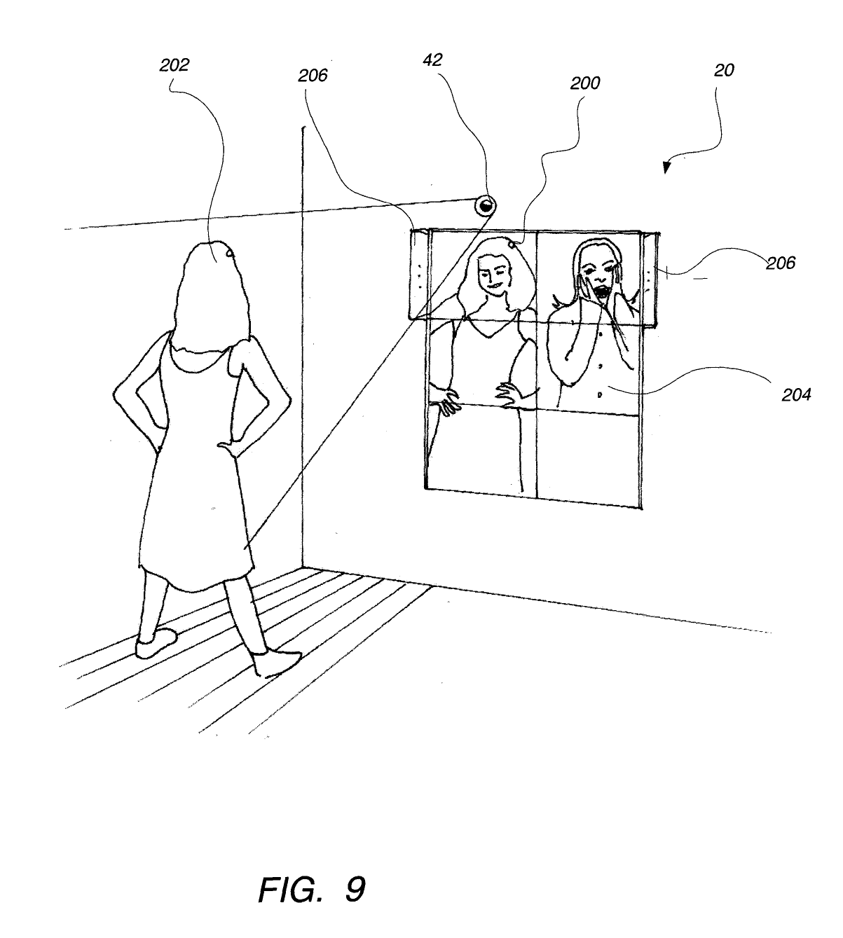

As is shown in FIG. 9, presentation system 10 can be usefully applied for the purpose of video-conferencing. In this regard, audio system 26, user interface 38 and image capture unit 42 can be used to send and receive audio, video and other signals that can be transmitted to a compatible remote video conferencing system. In this application, presentation system 10 can receive signals containing content from the remote system and present video portions of this content on display device 20. As is shown in this embodiment, display device 20 provides a reflective image portion 200 showing user 202 a real reflected image or a virtual reflected image derived from images captured of presentation space A. A received content portion 204 of display device 20 shows video portions of the received content. The reflective image portion 200 and received content portion 204 can be differently sized or dynamically adjusted by user 202. Audio portions of the content are received and presented by audio system 26, which, in this embodiment includes speaker system 206.

As described above, presentation space monitoring system 40 comprises a single image capture unit 42. However, presentation space monitoring system 40 can also comprise more than one image capture unit 42.

In the above-described embodiments, the presentation space monitoring system 40 has been described as sampling presentation space A using image capture unit 42. However, presentation space A can be sampled in other ways. For example, presentation space monitoring system 40 can use other sampling systems such as a conventional radio frequency sampling system 43. In one popular form, people in the presentation space are associated with unique radio frequency transponders. Radio frequency sampling system 43 comprises a transceiver that emits a polling signal to which transponders in the presentation space respond with self-identifying signals. The radio frequency sampling system 43 identifies people in presentation space A by detecting the signals. Further, radio frequency signals in presentation space A such as those typically emitted by recording devices can also be detected. Other conventional sensor systems 45 can also be used to detect people in the presentation space and/or to detect the condition of people in presentation space A. Such detectors include switches and other transducers that can be used to determine whether a door is open or closed or window blinds are open or closed. People that are detected using such systems can be assigned with a profile during calibration in the manner described above with the profile being used to determine combined viewing privileges. Image capture unit 42, radio frequency sampling system 43 and sensor systems 45 can also be used in combination in presentation space monitoring system 40.

In certain installations, it may be beneficial to monitor areas outside of presentation space A but proximate to presentation space A to detect people such as people who may be approaching the presentation space. This permits the content on the display or audio content associated with the display to be adjusted before presentation space A is encroached or entered such as before audio content can be detected. The use of multiple image capture units 42 may be usefully applied to this purpose as can the use of radio frequency sampling system 43 or sensor system 45 adapted to monitor such areas.

Image modulator 70 has been described herein above as involving an array 82 of micro-lenses 84. The way in which micro-lenses 84 control the angular range, a, of viewing space 72 relative to a display can be defined using the following equations for the angular range, a, in radians over which an individual image is visible, and the total field, q, also in radians before the entire pattern repeats. They depend on the physical parameters of the lenticular sheet, p, the pitch in lenticles/inch, t, the thickness in inches, n, the refractive index, and M, the total number of views you put beneath each lenticle. The relationships are:
a=n/(M*p*t), (1)
and
q=n/(p*t) (2)
The refractive index, n, does not have a lot of range (1.0 in air to 1.6 or so for plastics). However, the other variables do. From these relationships it is evident that increasing one or all of M, p and t leads to narrower view (or more isolated) viewing space. Increased M means that the area of interest must be a very small portion of the width of a micro-lens 84. However, micro-lenses 84 are ideal for efficient collection and direction of such narrow lines of light. The dilemma is that increased p and t can also lead to repeats of areas in which the content can be observed. This is not ideal for defining a single isolated region for observation. One way to control the viewing space using such an array 82 of micro-lenses 84 is to define the presentation space so that the presentation space includes only one repeat.

In other embodiments, other technologies can be used for performing the same function described herein for image modulator 70. For example, optical barrier technologies can be used in the same manner as described with respect to array 82 of micro-lenses 84 to provide a controllable viewing space within a presentation space. One example of such an optical barrier technology is described in commonly assigned U.S. Pat. No. 5,828,495, entitled “Lenticular Image Displays With Extended Depth” filed by Schindler et al. on Jul. 31, 1997. Such barrier technology, avoids repeats in the viewing cycle, but can be inefficient with light.

In one embodiment of the invention, display device 20 and image modulator 70 can be combined. For example, in one embodiment of this type image modulator 70 can comprise an adjustable parallax barrier that can be incorporated in a display panel. The adjustable parallax barrier can be made switchable between a state that allows only selected portions of a back light to pass through the display. This allows control of the path of travel of the back lighting passing through the display and makes it possible to display separate images into the display space so that these separate images are viewable in the presentation space. One example of an LCD panel of this type is the Sharp 2d/3d LCD display developed by Sharp Electronics Corporation, Naperville, Ill., USA.

As disclosed by Sharp in a press release dated Sep. 27, 2002, this parallax barrier is used to separate light paths for light passing through the LCD so that different viewing information reaches different eyes of the viewer. This allows for images to be presented having parallax discrepancies that create the illusion of depth. The adjustable parallax barrier can be disabled completely making it transparent for presenting conventional images. It will be appreciated that this technology can be modified so that when the parallax barrier is active, the same image is presented to a limited space or spaces relative to the display and so that when the parallax barrier is deactivated, the barrier allows content to be presented by the display in a way that reaches an entire display space. It will be appreciated that such an adjustable optical barrier can be used in conjunction with other display technologies including but not limited to OLED type displays. Such an adjustable optical barrier can also be used to enhance the ability of the display to provide images that are viewable only within one or more viewing spaces.

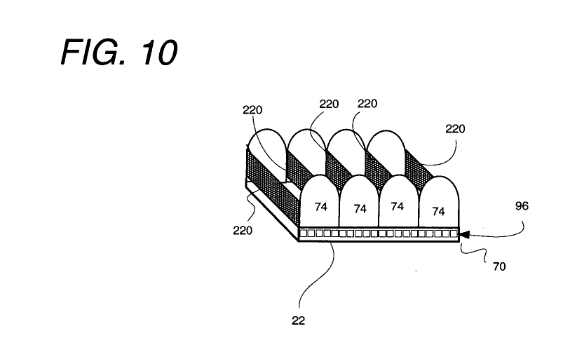

Another embodiment is shown in FIG. 10, an array 82 of individual hemi-cylindrical micro-lenses 84 with physical or absorbing barriers 210 between each micro-lens 84, is provided that has the advantages of both of the above approaches. It eliminates repeat patterns, allowing the adjustment of pitch, p and thickness, t, to define an exclusive or private viewing region. This viewing region is further restricted by a narrowing of the beam of light (i.e. effectively, higher value of M). The lens feature eliminates the loss of light normally associated with traditional slit-opening barrier strips.

In still another embodiment of this type, a “coherent fiber optic bundle” which provides a tubular structure of tiny columns of glass that relay an image from one plane to another without cross talk can be used to direct light along a narrow viewing range to an observer. For example such a coherent fiber optic bundle can be defined in the form of a fiber optic face plate for transferring a flat image onto a curved photomultiplier in a night vision device. Using the same concept as in FIG. 10, micro-lenses 84 formed at the end of each fiber column would allow the direction of light toward a specific target, narrowing the observable field to a small X and Y region in space.

It will be appreciated that the present invention, while particularly useful for improving the confidentiality of information presented by a large scale video display system, is also useful for other smaller systems such as video displays of the types used in video cameras, personal digital assistants, personal computers, portable televisions and the like.

The invention has been described in detail with particular reference to certain preferred embodiments thereof, but it will be understood that variations and modifications can be effected within the spirit and scope of the invention. However, the various components of presentation system 10 shown in FIG. 1 can be separated and/or combined with other components to provide the claimed features and functions of the present invention.

### Parts List

10 presentation system
20 display device
22 source of image modulated light
24 display driver
26 audio system
30 control system
32 signal processor
34 controller
36 supply of content
38 user interface
40 presentation space monitoring system
42 image capture unit
43 radio frequency sampling system
44 taking lens unit
45 sensor system
46 image sensor
48 processor
50 person
51 wall
52 person
54 person
56 door
58 window
60 source of personal profiles
70 image modulator
72 viewing space
74 width of viewing space
76 depth of viewing space
78 near viewing distance
80 far viewing distance
82 array of microlenses
84 micro-lenses
86 image elements
88 optical axis
90 position
92 position
94 position
96 group width
98 range of viewing position
110 Initialize step
112 sample presentation space step
114 locate step
116 define viewing space step
118 present content to viewing space step
120 continue determination step
122 obtain calibration images step
124 record calibration information step
126 associate profile information step
128 store calibration images and information step
140 select content for presentation step
142 determine profile for content step
144 determine display mode step
146 normal display step
147 continue display step
148 sample presentation space step
150 locate people in presentation space step
152 determine personal profile step
154 define viewing space step
155 present content step
156 continue determining step
200 image portion
202 user
204 content portion
206 speaker system
210 absorbing barrier
A presentation space
V group of image elements
V′ viewing space
W group of image elements
W′ viewing space
X group of image elements
X′ viewing space
Y group of image elements
Y′ viewing space
Z group of image elements
Z′ viewing space

1. A method for operating a display capable of presenting content within a presentation space, the method comprising the steps of:
locating a person in the presentation space;
defining a viewing space comprising less than all of the presentation space and including the location of the person; and
presenting content so that the presented content is discernable only within the viewing space.

2. The method of claim 1, further comprising the steps of detecting changes in the location of the person during presentation of the content and changing the viewing space so that the viewing space follows the location of the person.

3. The method of claim 1, wherein the viewing space is limited to a space that is no less than the eye separation of eyes of the person.

4. The method of claim 1, wherein the viewing space is defined in part based upon a shoulder width of the person.

5. The method of claim 1, wherein the viewing space is defined at least in part by at least one of a near viewing distance comprising a minimum separation from the display at which the person can discern the content presented to the viewing space and a far viewing distance comprising a maximum distance from the display at which a person can discern content presented to the viewing space.

6. The method of claim 1, wherein the step of presenting the content to the viewing space comprises using the display to present content in the form of patterns of emitted light and filtering the emitted light so that the content can be discerned only in the viewing space.

7. The method of claim 1, wherein the step of presenting the content to the viewing space comprises using the display to present content in the form of patterns of emitted light and focusing patterns of emitted light so that the content can be discerned only in the viewing space.

8. The method of claim 1, wherein the step of presenting the content to the viewing space comprises using the display to present content in the form of patterns of emitted light and directing the content so that the content can be discerned only in the viewing space.

9. The method of claim 1, further comprising the steps of detecting at least one additional person in the presentation space, defining an additional viewing space for each additional person and presenting the content to each viewing space.

10. The method of claim 1, further comprising the steps of detecting movement of a detected person outside of the presentation space during presentation of the content and automatically suspending presentation of the content to a viewing space for that person.

11. The method of claim 1, further comprising the step of presenting audio content directed to the viewing space.

12. The method of claim 1, wherein the viewing space is less than all of a vertical portion of the presentation space.

13. The method of claim 1, wherein the viewing space is less than all of a horizontal portion of the presentation space.

14. A method for presenting content using a display, the method comprising the steps of:
detecting people in a presentation space within which content presented by the display can be observed;
identifying people in the presentation space who are authorized to observe the content;
defining a viewing space for each authorized person with each viewing space comprising less than all of the presentation space and including space corresponding to an authorized person; and,
presenting content to each viewing space.

15. The method of claim 14 wherein the step of identifying people in the presentation space who are authorized to observe the content comprises classifying each detected person in determining whether each detected person is authorized to observe the content, based upon the classification for that person.

16. The method of claim 14 wherein the step of identifying people in the presentation space or authorized to observe the content comprises identifying each detected person and using the identity of the person to determine whether the person is authorized to observe the content.

17. The method of claim 14 wherein the step of identifying people in the presentation space who are authorized to observe content comprises determining a profile for each person and using the profile for each person to determine whether the person is authorized to observe the content.

18. The method of claim 17 further comprising the step of determining a profile for the content and wherein the step of using the profile for each person to determine whether the person is authorized to observe the content comprises comparing the profile for each person to the profile for the content.

19. The method of claim 18, further comprising the steps of monitoring the display space during presentation of the content to detect whether more than one person enters a common viewing space, combining the profiles of each person in the common viewing space and determining whether to present content to the common viewing space based upon the combined profiles of the viewers and the profile of the content.

20. The method of claim 19, wherein each personal profile contains viewing privileges and the content profile contains access privileges wherein the viewing privileges are combined in an additive manner and the common viewing space is defined based upon the combined viewing privileges and the access privileges.

21. The method of claim 19, wherein the personal profiles contain viewing privileges, and the content profile contains access privileges wherein the step combining viewing privileges are combined in a subtractive manner and the presentation of the content is adjusted based upon the combined viewing privileges and the access privileges.

22. The method of claim 18, wherein the content profile contains viewing privileges associated with particular portions of the content and wherein display of particular portions of the content to the common presentation space is adjusted based upon the personal profiles of the persons in the common viewing space and the viewing privileges of associated with those particular portions.

23. The method of claim 14, wherein the step of detecting people in the presentation space comprises capturing an image of the presentation space and analyzing the image to detect the people.

24. The method of claim 14, wherein the step of detecting people in the presentation space comprises detecting radio frequency signals from transponders in the presentation space and identifying people in the presentation space based upon the detected radio frequency signals.

25. The method of claim 14, further comprising the step of detecting signals from sensors adapted to detect encroachment of the presentation space and adjusting the presentation of the content when such encroachment is detected.

26. A method for operating a display capable of presenting content discernable in a presentation space, the method comprising the steps of:
selecting one of a general display mode and a restricted display mode;
presenting content to the presentation space when the general display mode is selected; and
performing, when the restricted display mode is selected, the steps of:
locating a person in the presentation space;
defining a viewing space comprising less than all of the presentation space and including the location of the person; and
presenting content so that the presented content is discernable only within the viewing space.

27. The method of claim 26, wherein the step of selecting one of a general display mode and a restricted display mode comprises selecting a mode based upon analysis of the content.

28. The method of claim 26, wherein the step of selecting one of a general display mode and a restricted display mode comprises selecting a mode based upon a personal profile.

29. The method of claim 26, wherein the step of selecting one of a general display mode and a restricted display mode comprises selecting a mode based upon the content of the scene.

30. A method for operating a display capable of presenting content within a presentation space, the method comprising the steps of:
selecting content for presentation;
determining access privileges for a person to observe the content;
operating the display in a first mode wherein the content is displayed to the presentation space when the access privileges are within a first range of access privileges; and
operating the display in a second mode when the access privileges are within a second range of access privileges wherein during the second mode, a viewing space is defined comprising less than all of the presentation space and including the location of the person and content so that the presented content is discernable only within the viewing space.

31. A control system for presenting images to at least one person in a presentation space, the control system comprising:
a presentation space monitoring system generating a monitoring signal representative of conditions in the presentation space within which content presented by a display can be discerned;
an image modulator positioned between the display and the presentation space with the image modulator adapted to receive patterns of light presented by the display and to modulate the patterns of light emitted by the display so that the patterns of light are discernable only within spaces defined by the image modulator; and,
a processor adapted to determine the location of each person in the presentation space based upon the monitoring signal and to determine a viewing space for each person in said presentation space comprising less than all of the presentation space and also including the location of each person;
wherein the processor causes the image modulator to modulate the light emitted by the display so that the pattern of light emitted by the display is discernable only in the viewing space.

32. The control system of claim 31, wherein the presentation space monitoring system comprises an image capture system adapted to capture an image of the presentation space and the processor detects people in the presentation space by analyzing the captured image.

33. The control system of claim 31, wherein the presentation space monitoring system comprises a radio frequency signal detection system adapted to detect signals in the presentation space and the processor detects the person in the presentation space based upon the detected radio frequency signals.

34. The control system of claim 31, wherein the presentation space monitoring system comprises a sensor system adapted to sense conditions in the presentation space and to generate the monitoring signal based upon the sensed conditions and the processor detects the person in the presentation space based upon the monitoring signals.

35. The control system of claim 31, wherein the processor is further adapted to detect changes in the location of the person during presentation of the content and to change the viewing space to so that the viewing space follows the location of the person.

36. The control system of claim 31, wherein the viewing space is limited to a space that is no less than the eye separation of eyes of the person.

37. The control system of claim 31, wherein the viewing space is defined in part based upon a shoulder width of the person.

38. The control system of claim 31, wherein the viewing space is defined at least in part by at least one of a near viewing distance comprising a minimum separation from the display at which the person can discern the content presented to the viewing space and a far viewing distance comprising a maximum distance from the display at which a person can discern content presented to the viewing space.

39. The control system of claim 31, wherein the image modulator comprises a filter that is adjustable in response to signals from the processor to filter the emitted light so that the content can be discerned only in the viewing space.

40. The control system of claim 31, wherein the image modulator comprises a lens system to focus patterns of emitted light so that the content can be discerned only in the viewing space.

41. The control system of claim 31, wherein the image modulator comprises an array of lenslets adapted to direct light in a plurality of directions and wherein the processor causes the display to present images in a manner such that the images are visible in one of the directions.

42. The control system of claim 31, wherein the image modulator comprises an optical system that focuses the patterns of light emitted by the display so that the light forms an image only after a near depth of field.

43. The control system of claim 31, wherein the image modulator comprises an optical system that focuses the patterns of light emitted by the display so that the light forms an image only before a far depth of field.

44. The control system of claim 31, wherein the image modulator comprises a set of baffles that direct light to the viewing space.

45. The control system of claim 31, wherein the modulator comprises a coherent fiber optic bundle which provides a channel structure of paths of generally transparent material.

46. The control system of claim 31 wherein the modulator comprises an array of individual micro-lens having physical light absorbing barriers between each micro-lens.

47. The control system of claim 31, wherein the processor is further adapted to detect at least one additional person in the presentation space, define an additional viewing space for each additional person and cause the image modulator and display to cooperate to present the content to each viewing space.

48. The control system of claim 31, wherein the processor is further adapted to detect movement of a detected person outside of the presentation space during presentation of the content and automatically suspending presentation of the content to a viewing space for that person.

49. The control system of claim 31, further comprising a directed audio system for directing audio signals to the viewing space.

50. A control system for a display adapted to present images in the form of patterns of light that are discernable in a presentation space, the control system comprising:
a presentation space monitoring system generating a monitoring signal representative of conditions in the presentation space;
an image modulator positioned between the display and the person with the image modulator adapted to receive patterns of light presented by the display and to modulate the patterns of light emitted by the display so that the patterns of light are discernable only within spaces defined by the image modulator; and,
a processor adapted to detect each person in the presentation space based upon the monitoring signal, to identify authorized persons based on this comparison; and to determine a viewing space for each authorized person said viewing space comprising less than all of the presentation space and also including the location of the person;
wherein the processor causes the image modulator and the display to cooperate to modulate the light emitted by the display so that the pattern of light emitted by the display is discernable only viewing spaces for authorized persons.

51. The control system of claim 50, wherein the processor identifies people in the presentation space who are authorized to observe the content by classifying each detected person, and determines whether each detected person is authorized to observe the content, based upon the classification for that person.

52. The control system of claim 51 wherein the processor is adapted to identify people in the presentation space who are authorized to observe the content by identifying each detected person and using the identity of the person to determine whether the person is authorized to observe the content.

53. The control system of claim 50 wherein the processor is adapted to people in the presentation space who are authorized to observe content by determining a profile for each detected person and using the profile for each detected person to determine whether the detected person is authorized to observe content.

54. The control system of claim 53 wherein the processor is further adapted to determine a profile for the content and wherein the processor uses the profile for each person to determine whether each person is authorized to observe the content by comparing the profile for each person to the profile for the content.

55. The control system of claim 53 wherein the processor examines the monitoring signal to detect whether more than one person enters a common viewing space, combines the profiles of each person in the common viewing space and determines whether to present content to the common viewing space based upon the combined profiles for each person and the profile of the content.

56. The control system of claim 53, wherein each personal profile contains viewing privileges and the content profile contains access privileges wherein the viewing privileges are combined in an additive manner and the common viewing space is defined based upon the combined viewing privileges and the access privileges.

57. The control system of claim 50, wherein the personal profiles contain viewing privileges, and the content profile contains access privileges wherein the step combining viewing privileges are combined in a subtractive manner and the presentation of the content is adjusted based upon the combined viewing privileges and the access privileges.

58. The control system of claim 50, wherein the content profile contains viewing privileges associated with particular portions of the content and wherein display of particular portions of the content to the common presentation space is adjusted based upon the personal profiles of the persons in the common viewing space and the viewing privileges of associated with those particular portions.

59. The control system of claim 50, wherein the step of determining a profile for each of each person by classifying each person and assigning viewing privileges to each person based upon the classification.

60. A control system for a display adapted to present images in the form of patterns of light that are discernable in a presentation space, the control system comprising:
a presentation space monitoring system generating a monitoring signal representative of conditions in the presentation space;
an image modulator positioned between the display and the person with the image modulator adapted to receive patterns of light presented by the display and for modulating the patterns of light emitted by the display;
a processor adapted to select between operating in a restricted mode and a general mode;
with the processor further being adapted to, in the general mode, cause the image modulator and display to present content in a manner that is discernable throughout the display space and with the processor further being adapted to, in the restricted mode, detect each person in the presentation space based upon the monitoring signal, define viewing spaces for each person in the presentation space and cause the image modulator and display to cooperate to present images that are discernable only within each viewing space.

61. The control system of claim 60, wherein the processor selects one of a general display mode and a restricted display mode based upon analysis of the content.

62. The control system of claim 60, further comprising a source of personal profile information wherein the processor selects a display mode based upon a personal profile obtained from the source of personal profile information.

63. The control system of claim 60, further comprising user controls wherein the step of selecting one of a general display mode and a restricted display mode comprises selecting a mode based upon a signal from the user control.

64. A control system for a display adapted to present light images to a presentation space, the control system comprising:
a detection means for detecting at least one person in the presentation space;
an image modulator for modulating the light images;
a processor for defining individual viewing spaces around each person with each viewing space comprising less than the entire presentation space and for causing the image modulator and display to display content only to the individual viewing spaces.

65. The control system of claim 64, wherein said image modulator comprises an optical barrier.

66. The control system of claim 64, wherein said image modulator comprises an array of detectable optical pathways and said processor causes the optical pathways to be directed to the viewing space.

67. The control system of claim 64, wherein each of said optical pathways comprises a micro-lens.

68. A control system for a display adapted to present light images to a presentation space, the control system comprising:
a detection means for detecting at least one person in the presentation space;
an image modulator for modulating the light images;
a processor adapted to obtain images for presentation on the display, to determine a profile for the obtained images and to select a mode of operation based upon information contained in the profile for the obtained images, wherein the processor is operable to cause the display to present images in two modes and selects between the modes based upon the images profile information, and wherein in one mode the images is presented to the presentation space and in another mode at least one viewing space is defined around each person with each viewing space comprising less than the entire presentation space and to cause images to be formed on the display in a way such that when the images are modulated by the image modulator so that the images are only viewable to a person in the at least one viewing space.

69. The control system of claim 68 further comprising a directional audio system adapted to direct audio signals to a portion of the presentation space, wherein the processor is further adapted to direct audio signals associated with the images to the viewing space.
